(19) United States
(12) Patent Application Publication
(10) Pub. No.: US 2006/0104774 A1
(43) Pub. Date: May 18, 2006

(54) Mobile receptacle for a catching debris

(76) Inventors: LaVerne M. Sessler JR., Geneva, NY (US); Craig L. Sessler, Geneva, NY (US)

Correspondence Address: HOWARD J. GREENWALD P.C., 349 W. COMMERCIAL STREET SUITE 2490, EAST ROCHESTER, NY, 14445-2408, US

(21) Appl. No.: 11/219,371

(22) Filed: Sep. 2, 2005

Related U.S. Application Data
(63) Continuation-in-part of application No. 10/325,357, filed on Dec. 18, 2002, now abandoned.

(51) Int. Cl. B60P 1/00

(52) U.S. Cl. 414/539

(57) ABSTRACT

A mobile receptacle for catching debris comprised of two contiguously retractable wings connected to the receptacle, hydraulic cylinder assemblies for raising and lowering the contiguously retractable wings, two movable outriggers connected to the movable receptacle, hydraulic cylinders for raising and lowering such outriggers, and a hydraulic cylinder for raising and lowering the receptacle.

### CROSS-REFERENCE TO RELATED PATENT APPLICATIONS

This application is a continuation-in-part of applicants' co-pending patent application Ser. No. 10/325,357 (filed on Dec. 18, 2002). The content of the aforementioned patent application is hereby incorporated by reference into this specification.

### FIELD OF THE INVENTION

An apparatus for catching debris produced when a bridge or other structure disposed above the apparatus is demolished.

### BACKGROUND OF THE INVENTION

In applicant's U.S. Pat. No. 6,155,649, the entire disclosure of which is hereby incorporated by reference into this specification, there is disclosed and claimed a process for demolishing a bridge deck by means of a truck assembly equipped with a receptacle comprised of a right side and a left side, a first wing rotatably connected to said right side of said receptacle, comprising the steps of: (a) disposing said truck assembly beneath said bridge deck, (b) rotating said first wing upwardly and outwardly from said right side of said receptacle to a first position, (c) supporting said first wing in said first position by means of a support contiguous with said first wing, (d) demolishing said bridge deck and causing debris to fall therefrom, (d) receiving said debris from said bridge deck within said receptacle, (e) ceasing supporting said first wing in said first position and moving said first wing downwardly and inwardly towards said right side of said receptacle, (f) moving said truck assembly, and (g) removing said debris from said receptacle.

The dependent claims in U.S. Pat. No. 6,155,649 describe other embodiments of the process in which “ . . . said truck assembly is comprised of a second wing rotatably connected to said left side of said receptacle . . . ” (claim 2), “ . . . said means of support is comprised of a first hydraulic cylinder assembly comprised of a first hydraulic cylinder, a second hydraulic cylinder disposed within said first hydraulic cylinder, and a first rod disposed within said second hydraulic cylinder . . . ” (claim 3), “ . . . said first hydraulic cylinder assembly is contiguous with said first wing . . . . ” (claim 4), “ . . . said means of support is comprised of a second hydraulic cylinder assembly comprised of a third hydraulic cylinder, a fourth hydraulic cylinder disposed within said third hydraulic cylinder, and a second rod disposed within said fourth hydraulic cylinder . . . ” (claim 5), “ . . . said second hydraulic cylinder assembly is contiguous with said second wing . . . ” (claim 6), “ . . . the step of supporting said first wing by means of said first hydraulic cylinder assembly . . . ” (claim 7), “ . . . the step of supporting said second wing by means of said second hydraulic cylinder assembly . . . ” (claim 8), “ . . . the step of extending said second hydraulic cylinder away from said first hydraulic cylinder, thereby rotating said first wing upwardly and outwardly from said right side of said receptacle . . . ” (claim 9), “ . . . the step of extending said fourth hydraulic cylinder away from said third hydraulic cylinder, thereby rotating said second wing upwardly and outwardly from said left side of said receptacle . . . ” (claim 10), “ . . . the step of extending said first rod away from said second hydraulic cylinder, thereby rotating said first wing upwardly and outwardly from said right side of said receptacle . . . ” (claim 11), “ . . . the step of extending said second rod away from said fourth hydraulic cylinder, thereby rotating said second wing upwardly and outwardly from said left side of said receptacle . . . ” (claim 12), “ . . . . the step of moving said first rod towards said second hydraulic cylinder, thereby rotating said first wing downwardly and inwardly towards said right side of said receptacle . . . ” (claim 13), “ . . . the step of moving said second rod towards said fourth hydraulic cylinder, thereby rotating said second wing downwardly and inwardly towards said left side of said receptacle . . . ” (claim 14), “ . . . the step of moving said second hydraulic cylinder towards said first hydraulic cylinder, thereby rotating said first wing downwardly and inwardly towards said right side of said receptacle . . . ” (claim 15) and the step of moving said fourth hydraulic cylinder towards said third hydraulic cylinder, thereby rotating said second wing downwardly and inwardly towards said left side of said receptacle . . . ” (claim 16). These process steps, and the preferred devices for performing them, are disclosed in such U.S. Pat. No. 6,155,649, the entire disclosure of which is hereby incorporated by reference into this specification.

In performing the process disclosed in this patent, an apparatus is required which enables the mobile receptacle to be transported on public highways, according to transportation, environmental, and safety regulations imposed by local, state, and federal jurisdictions. In order to meet such regulations, unique capabilities and features must be provided in such an apparatus.

The design of the present invention offers substantial improvement and advantage over other prior art nesting configurations for hydraulic apparatus. By incorporating its novel cylinder assembly nesting configuration, the present invention provides an apparatus with a low-profile and protrusion that is substantially the dimension of only a single member. While there are many commercial mobile receptacles for motor vehicles currently available, Applicant believes that none offer the improvements and advantages of the present invention.

For example, U.S. Pat. No. 5,016,858, describes a hydraulic lift mechanism for raising and lowering heavy loads having a first member, a second member, and a third member. When fully lowered, the lowest profile height is substantially the same as that of the combination between the first and second members' heights, while the present invention's configuration offers a profile whose protrusion is substantially the dimension of only a single member. More importantly, said patent teaches a low profile as to height only (desirable to provide standing room for an adult in a camper-type attachment to a truck) and fails to teach an apparatus that provides a low profile as to width.

The spatial relationship of the recess in the parallel wall, the recess in the parallel wing and the cylinder allow the novel feature of a wing recess nesting within a wall recess and the further advantage of a narrow gap between the outer surface of the box and the inner surface of the wing. Specifically, when the retractable wing is in a retracted position, a gap of less than about two inches is formed between the outer surface of the first parallel wall and the inner surface of the first contiguously retractable wing such that the first hydraulic cylinder nested in the vertically disposed wall recess and wing recess has a protrusion substantially the dimension of the width of the wing panel. Applicant believes that none of the existing mobile refuse receptacles offer the recited improvements and advantages of the present invention.

The present invention additionally offers significant advantage over the prior art in that the outrigger and stabilizer is located at the end of the box rather than on the sides of the box. This feature functions to reduce or minimize the width profile of the mobile receptacle, thereby enabling it to be transported on public highways in compliance with transportation statutes and regulations. Additionally, locating the stabilizers proximate to the hinge of the dump trailer enhances the functionality of the stabilizing force, increasing safety during operation.

For example, U.S. Pat. No. 3,337,063 describes (at claim 2, column 4, lines 27-30) a hydraulically controlled linkwork stabilizer for truck cranes that incorporates an “upper link [that] is triangular and the respective pivotal connection of said upper link is triangular and the respective pivotal connections thereof are located at the vertices of the triangle.” The entire patent is incorporated by reference into this specification. Claim 3 further claims an extensible outrigger mechanism “in which said mechanism is arranged to be extended from one side of the vehicle; and a second identical mechanism arranged to be extended from the opposite side of the trailer; the two hydraulic cylinder means being pivotally connected to the vehicle frame at a common point.” The described and claimed stabilizer incorporates a linkage system that expands and retracts around three fixed points. In contrast, the present invention offers a simpler design that does not require three links and a linkage system. The design of the present invention has fewer moving parts for wear and repair. In fact, modification of the device in U.S. Pat. No. 3,337,063 as taught by the present invention would render such system inoperable, contraindicating that the present invention was an obvious application of or modification of the prior art.

The present invention additionally offers significant advantage over the prior art in that no hanger bracket is required for mounting or securing the wing panel. This feature reduces the weight load of the vehicle with the mobile receptacle, promoting compliance with transportation authority weight limit regulations.

It is therefore an object of this invention to provide an improved apparatus for catching debris produced while a structure is being demolished.

It is a further object of this invention to provide a nesting configuration for hydraulic members of a mobile debris catching apparatus that reduces the profile of said mobile apparatus.

It is a further object of this invention to provide an apparatus which may be transported on public highways in compliance with transportation statutes and regulations.

It is a further object of this invention to provide an apparatus which may be safely operated when catching debris produced while a structure is being demolished.

### SUMMARY OF THE INVENTION

In accordance with this invention, there is provided a mobile receptacle for catching debris comprised of a base; a box comprising a pair of parallel walls extending upwardly from a flat bed; and a first contiguously retractable wing connected to one of the parallel walls of the box of the receptacle.

In accordance with this invention, there is provided a mobile receptacle further comprising a second contiguously retractable wing connected to the second of the parallel walls of the box of the receptacle.

In accordance with this invention, there is provided a contiguously retractable wing for directing debris into a receptacle comprising a hanger bracket suspendable upon an upper edge of a wall of the receptacle; a wing panel; and a hydraulic cylinder assembly operatively connected to the hanger bracket and to the wing panel.

### BRIEF DESCRIPTION OF THE DRAWINGS

The invention will be described by reference to the following drawings, in which like numerals refer to like elements, and in which:

FIG. 1 is a perspective view of one preferred apparatus of the invention;

FIG. 2 is a back elevation view of one embodiment of the mobile receptacle apparatus;

FIG. 3 is a back elevation view of a preferred embodiment of the mobile receptacle apparatus;

FIG. 4 is a sectional view of a contiguously retractable wing of the apparatus of the present invention, shown in the retracted position;

FIG. 5 is a sectional view of a contiguously retractable wing of the apparatus of the present invention, shown in a deployed position;

FIG. 6 is an exploded view of a hanger bracket of the apparatus of the present invention;

FIG. 7 is a side view of a hanger bracket of the apparatus of the present invention;

FIG. 8 is a side view of a wing of the apparatus of the present invention;

FIG. 9 is a top view of a wing of the apparatus of the present invention;

FIG. 10 is an end view of a wing of the apparatus of the present invention;

FIG. 11 is a perspective view of the nesting configuration of the attachment ears on a wing and contiguously retractable wing of the apparatus of the present invention,

FIG. 12 is a detailed perspective view of an attachment ear on a wing of the apparatus;

FIG. 13 is an elevation view of the apparatus of FIG. 1 showing the use of stabilizing means on level ground;

FIG. 14 is an elevation view of the apparatus of FIG. 1 showing the use of stabilizing means on uneven ground;

FIG. 15 is an elevation view of the apparatus of FIG. 1 showing an alternative use of stabilizing means on uneven ground;

FIG. 16 is an elevation view of an alternative stabilizing means of the invention in which two or more outriggers can be independently positioned and controlled;

FIG. 17 is a perspective view of the winged trailer assembly of FIG. 1 with its receptacle in the raised position.

FIG. 18 is a side view of the winged tractor-trailer assembly of FIG. 1 in which the stabilizing devices of the apparatus can accommodate uneven ground along the length of the winged tractor-trailer assembly;

FIG. 19 is a schematic view of a hydraulic circuit for operation of the dump box, the wings and the stabilizing means of the present invention; and

FIG. 20 is a schematic view of the operating control valves of the hydraulic circuit of FIG. 19;

FIG. 21 is a back elevation view of a further embodiment of a mobile receptacle which is buoyant in water;

### DESCRIPTION OF THE PREFERRED EMBODIMENTS

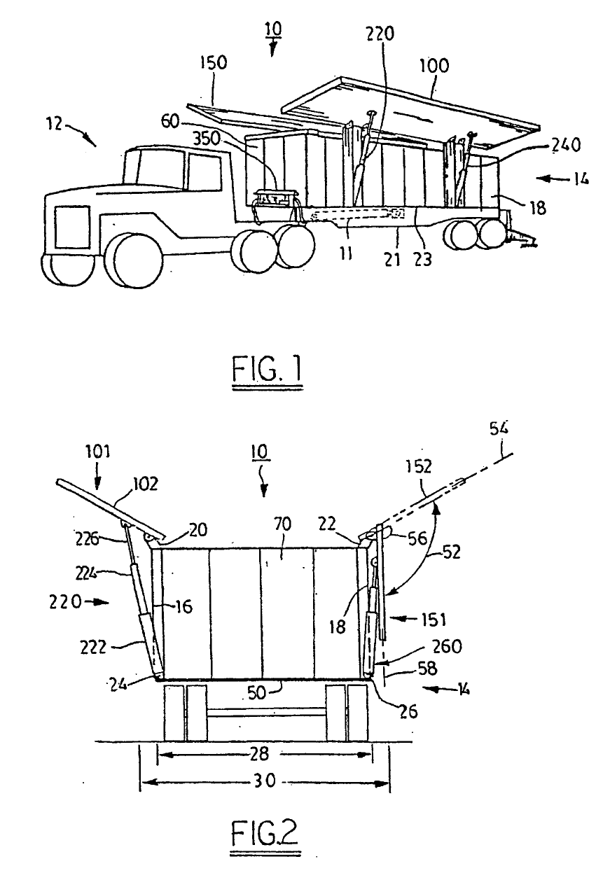

FIG. 1 illustrates one preferred embodiment of the invention, a winged tractor-trailer assembly 10. The device 10 depicted in FIG. 1 is but one embodiment of a mobile receptacle with a movable first wing, a movable second wing, hydraulic means for raising and lowering the first and second wings, means for raising and lowering the mobile receptacle, and means for stabilizing the raised receptacle.

Referring again to FIG. 1, and in the preferred embodiment depicted, a winged tractor-trailer 10 is depicted. The winged tractor-trailer 10 is comprised of a tractor 12 attached by conventional means to a rear dump trailer 14. As is known to those skilled in the art, a rear dump trailer is a mobile receptacle with means for removably connecting the trailer to a tractor (such as a truck), or other means for moving the trailer, a multiplicity of wheels attached to a base of the trailer, and means for removing debris contained in the box of the dump trailer by tilting the box up and away from the trailer base at an angle greater than about 30 degrees and removing the debris from the rear of the box.

Referring to FIGS. 1 and 2, the dump trailer 14 typically comprises a base 21 supporting a box 23, which comprises a substantially flat, rectangular bed 50, a pair of substantially parallel side walls 16 and 18, a front wall 60, and a rear wall 70, all extending upwardly from the outer perimeter of flat bed 50. Dump trailer 14 and similar dump trailers are well known to those skilled in the art and are described, e.g., in U.S. Pat. No. 5,782,538 (end dump trailer), U.S. Pat. No. 5,681,095 (dump body for a vehicle), U.S. Pat. No. 5,662,374 (dump body), U.S. Pat. No. 5,482,356 (rear dump trailer), U.S. Pat. No. 4,968,096 (dump trailer with lifting mechanism), U.S. Pat. No. 4,659,147 (dump trailer), U.S. Pat. No. 4,616,879, and the like. The entire description of each of these United States patents is hereby incorporated by reference into this specification.

In one embodiment, not shown, a dump truck is used instead of the dump trailer assembly 14, wherein the tractor 12 and dump trailer 14 are integrated into a single unitary structure. Such dump trucks are well known to those skilled in the art and are described, e.g., in U.S. Pat. Nos. 5,588,712, 5,452,942, 5,407,251, 4,955,972, 3,881,764, 3,601,447, and the like. The disclosure of each of these United States patents is hereby incorporated by reference into this specification.

It will be apparent that other assemblies may be used in the process of this invention. What they all preferably have in common, however, is a receptacle for receiving debris, and some means of moving the receptacle, which means commonly comprise a set of at least two wheels operatively connected to a motor.

In another embodiment, a movable receptacle that does not contain motorized means is used to receive debris. Such receptacle may be, e.g., a trailer that is pushed or pulled by a motorized vehicle.

In yet another embodiment, discussed later in this specification, a barge comprised of a buoyant receptacle is disposed within a waterway underneath a bridge. See, e.g., applicant's U.S. Pat. No. 6,397,423, the entire disclosure of which is hereby incorporated by reference into this specification. Such a buoyant receptacle is made mobile by use of e.g. a marine motor, or by attachment to a tug boat.

Referring again to FIG. 1, and in the preferred embodiment depicted therein, it will be seen that dump trailer 14 is connected to wings 100 and 150. These wings 100 and 150 may be raised and/or lowered by a hydraulic lift system comprised of hydraulic cylinder assemblies 220 and 240, which raise and lower wing 100, and corresponding hydraulic cylinder assemblies (not shown), which raise wing 150.

In one preferred embodiment, each of the hydraulic cylinder assemblies 220 and 240 is preferably a multi-stage hydraulic cylinder assembly, and more preferably a two stage hydraulic cylinder assembly. Thus, e.g., referring to FIG. 2 and in the embodiment depicted therein, it will be seen that hydraulic cylinder assembly 220 is comprised of hydraulic cylinder 222, within which is disposed hydraulic cylinder 224, within which is disposed rod 226. Thus, the preferred two stage hydraulic lift system of FIG. 2 operates by first extending cylinder 224 by means of hydraulic pressure, and thereafter extending rod 226 by means of hydraulic pressure.

Two stage hydraulic cylinder assemblies, and means for controlling them, are well known to those skilled in the art and are described, e.g., in U.S. Pat. No. 5,829,947 (two stage hydraulic lift cylinder), U.S. Pat. No. 5,649,424 (two stage pressure cylinder), U.S. Pat. No. 5,551,391 (control system for two stage hydraulic lift cylinder), U.S. Pat. Nos. 5,467,754, 5,341,837, 5,241,935, 4,852,464 (two stage telescoping hydraulic cylinder), U.S. Pat. No. 4,172,612 (two stage telescopic hydraulic cylinder), and the like. The entire disclosure of each of these United States patents is hereby incorporated by reference into this specification.

In one preferred process of the invention, hydraulic cylinder 224 is first raised, and then rod 226 is then raised. Conversely, when hydraulic pressure has been removed, rod 226 is first retracted and lowered, and then hydraulic cylinder 224 is then retracted and lowered.

FIG. 2 illustrates wing 151 in its lowered position. Tractor-trailer assembly 10 and dump trailer 14 are considered mobile when wings 101 and 151 are in such retracted and lowered positions. For illustrative purposes, FIG. 2 further depicts wing 101 in its deployed or raised position, after wing 101 has been raised by means of two-stage hydraulic cylinder 220. It will be seen that wings 101 and 151 are moveable upwardly and outwardly in the manner indicated by arctuate arrow 52 to the position 54 depicted in dotted line outline. The angle 56 between the lowered position 54 of wing 151 and its raised position 58 is generally from about 10 to about 180 degrees. It is generally preferred that angle 56 be from about 60 to about 150 degrees and, even more preferably, from about 100 to about 150 degrees. It one preferred embodiment, the top surfaces 102 and 152 of wings 101 and 151 respectively, actually touch the bottom of the bridge structure being worked on (not shown).

Referring again to FIG. 2, and in the embodiment depicted therein, it will be seen that wings 101 and 151 are preferably rotatably attached to trailer walls 16 and 18 by means of brackets 20 and 22 respectively, which are preferably integrally joined to trailer 14 by conventional means, such as welding. Brackets 20 and 22 are also preferably connected to the wings 101 and 151 by conventional fasteners, such as, e.g., a solid pin. The two-stage hydraulic cylinder assemblies 220 and 260 are attached to trailer 14 by means of, e.g., brackets 24 and 26, each of which also is preferably integrally connected to trailer 14 by welding.

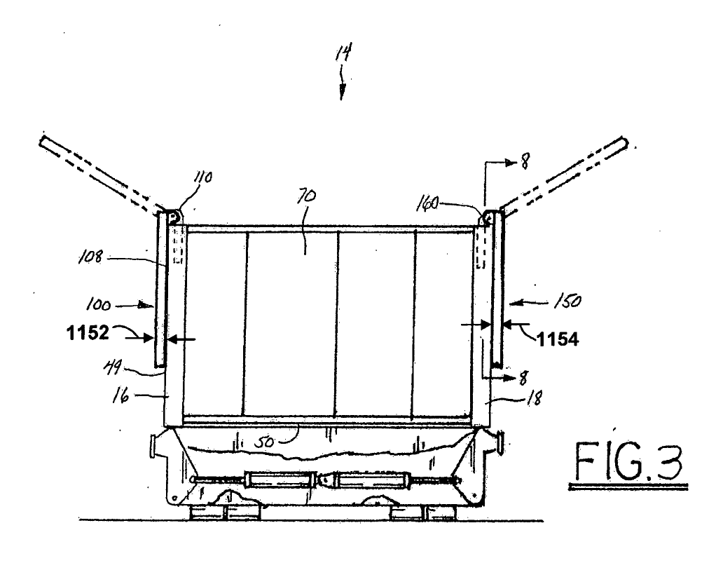

In the embodiment depicted in FIG. 2, and shown in FIG. 3 of the applicant's U.S. Pat. No. 6,155,649, wings 101 and 151 are deployable and retractable as previously described. However, it can be seen that wings 101 and 151 in their lowered positions still protrude horizontally outwardly from the sides 16 and 18 of dump trailer 14 a substantial distance, as indicated by lowered position 58 of wing 151. Such protrusion of the wings is not optimal, because with the width 28 of dump trailer 14 typically being very near the maximum width permitted for public highway transportation, such protrusion results in the requirement of having a “WIDE LOAD” permit, or more problematically, such protrusion may result in the total apparatus width 30 exceeding “WIDE LOAD” permit limits. In the worst of circumstances, such total apparatus width 30 would render the winged tractor trailer apparatus illegal and unsafe for use on public highways. In addition to problems with public highway transportation permits, such protrusion of the wings is also disadvantaged, as it renders dump trailer less stable and more prone to rollovers, and such protruding wings also increase wind drag and adversely impact fuel economy.

Accordingly, there is provided a preferred embodiment of the applicant's mobile receptacle having contiguously retractable wings as depicted in FIG. 3 through 12. FIG. 3 is a back elevation view of such a preferred embodiment of the mobile receptacle apparatus. Referring to FIG. 3, contiguously retractable wings 100 and 150 are depicted in the lowered or retracted position such that they are substantially contiguous with walls 16 and 18 of dump trailer 14. Wings 100 and 150 are mounted on dump trailer using hanger brackets 110 and 160.

Referring to FIGS. 3, 4, and 10, the term contiguous is used herein to describe the relationship between a wings 100 and 150, and a walls 16 and 18 respectively, of dump trailer 14. Such relationship will be described for wing 100 and wall 16 of dump trailer 14, with it being understood that such description applies analogously to wing 150 and wall 18 of dump trailer 14.

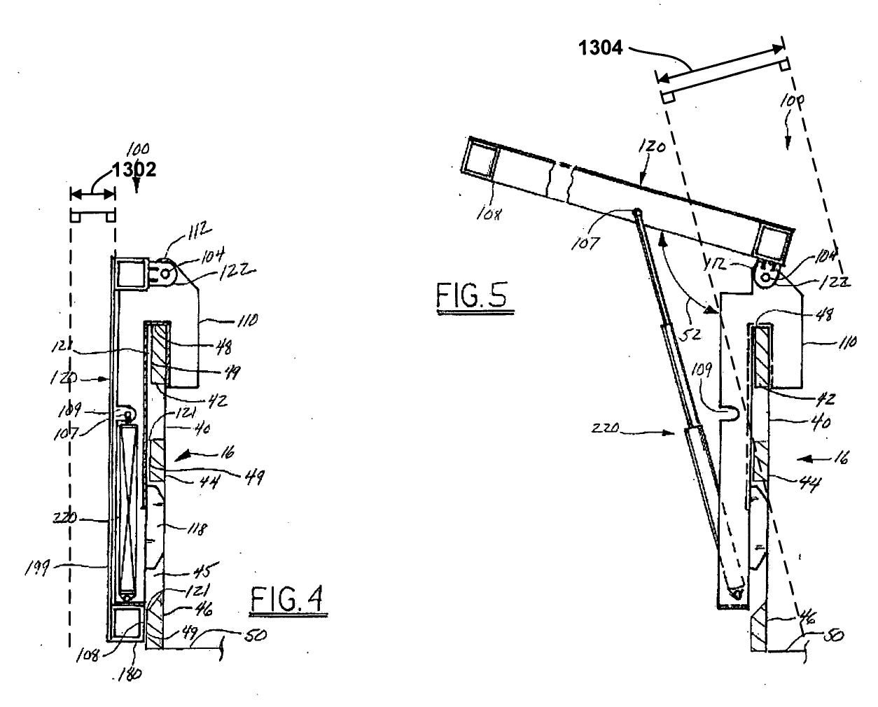

Referring to FIGS. 4 and 10, wing 100 comprises an outer surface 199 and an inner surface 108. Referring to FIG. 4, wall 16 of trailer 14 comprises an inner surface 40 formed by a liner, and an outer surface 49, typically formed by a matrix of hollow box beams such as e.g. beams 42, 44, and 46. As used herein, contiguous means that the inner surface 108 of wing 100, is in touching contact with the outer surface 49 of wall 16 of dump trailer 14; or there exists only a small air gap between the inner surface 108 of wing 100 and outer surface 49 of wall 16.

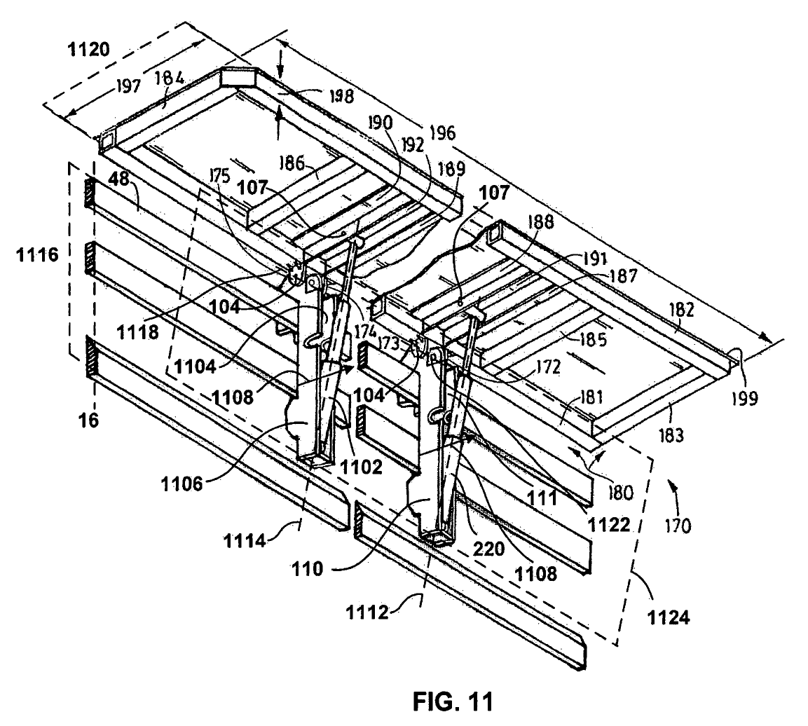

The parallel spatial relationship of the cylinder, the wing recess and the wall recess provide a nesting configuration that operates to minimize the air gap and the protrusion of the wing from the wall. See, e.g. FIG. 11, wherein hanger bracket 110 is nested entirely in recess 191 when hydraulic cylinder assembly 220 is in its retracted position (not shown) thereby forming a protrusion (see 1152 and 1154 of FIG. 3) of substantially the same magnitude as the wing panel 170 width 198 from wall 16 in the direction of 1108. In like manner, framework 180 further comprises angle pieces 189 and 190 disposed between upper box beam 181 and lower box beam 182, forming recess 192 therebetween, which provides a space 1104 for a second hydraulic cylinder assembly 1102 to reside when main wing panel 170 is in the retracted position.

In one embodiment, the gap 121 (see FIG. 4) between inner surface 108 of wing 100 and outer surface 49 of wall 16 is less than two inches wide. In a preferred embodiment, the gap 121 between inner surface 108 of wing 100 and outer surface 49 of wall 16 is less than one inch wide, and in a more preferred embodiment, the gap 121 between inner surface 108 of wing 100 and outer surface 49 of wall 16 is less than 0.25 inch wide.

It will be apparent to one skilled in the art that as wing panel 120 of wing 100 is a large structure, the precision with which wing panel is fabricated to minimize gap 121 is a matter of fabrication cost. At very high fabrication cost, the value of gap 121 can be made to approach zero.

The structures of wings 100 and 150 are such that when wings 100 and 150 are in the retracted position, the entire hydraulic assemblies previously described and shown in FIG. 2 are nested within mated recessed sections of such wings and brackets, as will be explained presently. Thus with the unique structure of wings 100 and 150 and their corresponding brackets 110 and 160, such wings are rendered contiguously retractable against the walls 16 and 18 of dump trailer 14. In contrast, wings 101 and 151 of the dump trailer 14 of FIG. 2 protrude horizontally when they are retracted, since there is no structure therein to house the hydraulic cylinder assemblies 220 and 260.

FIGS. 4 and 5 are sectional views of a contiguously retractable wing of the apparatus of the present invention shown mounted upon a dump trailer, in the retracted position and the deployed position, respectively. Referring to FIG. 4, wing 100 is mounted upon wall 16 of a dump trailer. Such a wall is typically constructed of a matrix of vertical hollow box beams (not shown), and horizontal hollow box beams 42, 44, and 46, to which is joined a liner 40 of sheet metal or other suitable sheet material. Thus the box beam matrix of the wall provides structural strength, while the sheet material provides the ability of complete containment of the material loaded therein.

Referring again to FIG. 4, wing 100 comprises hanger bracket 110, main wing panel 120, and hydraulic cylinder assembly 220. Hanger bracket 110 is suspended upon the upper edge 48 of wall 16 of the dump trailer. In a preferred embodiment, hanger bracket further comprises hydraulic hose protection extension 118, which closely fits into and engages with recess 45 that is formed between the vertical box beam (not shown), and the horizontal box beams 44 and 46 of the wall 16 of the dump trailer. Thus, when the dump trailer is being transported upon a roadway, the hanger bracket 110 and attached wing panel 120 are secured in place and restricted from any substantial horizontal movement along wall 16 of the dump trailer.

It can be seen from FIG. 4 that main wing panel 120 is retracted tightly against wall 16 of the dump trailer, and is substantially contiguous therewith. Hydraulic cylinder assembly 220 is nested entirely within a space formed by mated recessed sections of main wing panel 120 and hanger bracket 110.

FIG. 5 is a sectional view of contiguously retractable wing 100 of FIG. 4, shown in a deployed or raised position. Referring to FIG. 5, main wing panel 120 is upwardly and outwardly rotatable from hanger bracket 110 and wall 16 as indicated by arctuate arrow 52. In a preferred embodiment, main wing panel 120 comprises a pair of ears 122 joined by a pin 104 to a corresponding pair of ears 112 of hanger bracket 110. The position of ears 112 of hanger bracket 110 and ears 122 of main wing panel 120 are such that when wing panel 120 is fully retracted as shown in FIG. 4, wing panel 120 is substantially contiguous with wall 16 of the dump trailer.

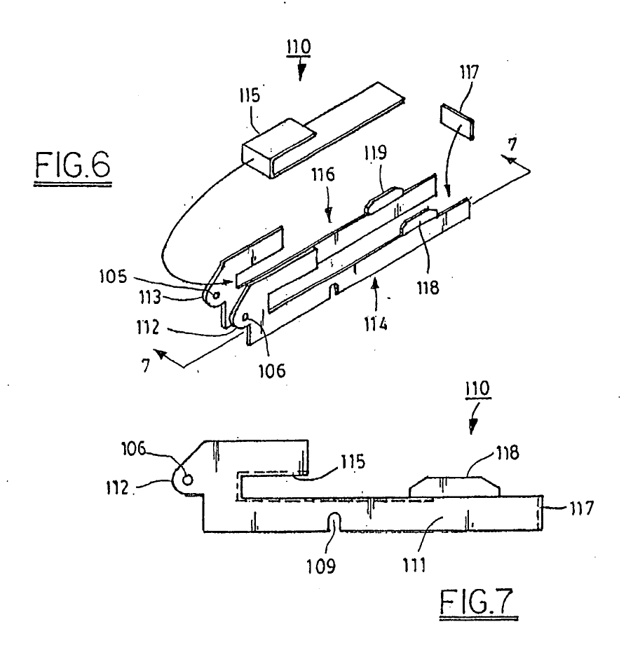

FIG. 6 is an exploded view of one preferred embodiment of hanger bracket 110 of FIGS. 4 and 5. Referring to FIG. 6, hanger bracket comprises a pair of substantially J-shaped plates 114 and 116, J-shaped channel 115, and end plate 117. J-shaped plate 114 comprises a hose protection extension 118, and a mounting ear 112, through which is provided a hole 106 for receiving pin 104 (see FIG. 5). In like manner, J-shaped plate 116 comprises a hose protection extension 119, and a mounting ear 113, through which is provided a hole 105 for receiving pin 104 (see FIG. 5).

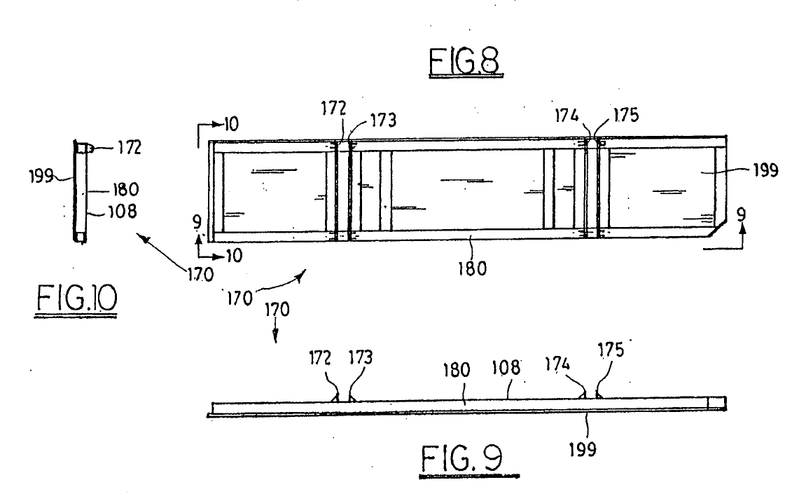

Hanger bracket 110 is assembled by joining J-shaped plates 114 and 116, J-shaped channel 115, and end plate 117 together, preferably by welding, to form a high strength unitary structure. In one preferred embodiment, J-shaped plates 114 and 116, J-shaped channel 115, and end plate 117 were made of ½-inch thick carbon steel welded together to form the hanger bracket 110 of FIG. 7.

FIG. 7 is a side view of a hanger bracket 110, taken along line 7-7 of FIG. 6. Referring to FIG. 7, the relationship between J-shaped plates 114 and 116 (hidden behind plate 114), J-shaped channel 115, and end plate 117 is depicted in the assembled state. Referring again to FIG. 7, and in one embodiment, hanger bracket 110 comprises notch 109. Such a notch 109 provides clearance for pin 107 of FIGS. 5 and 11, which joins wing panel 120 to hydraulic cylinder assembly 220, when the wing panel 120 is in the retracted position. (See FIG. 4.)

FIGS. 8, 9, and 10 are orthogonal views of a main wing panel of the present invention, taken from the side (FIG. 8), the bottom (FIG. 9), and the end (FIG. 10) thereof. For proper perspective with respect to the dump trailer of the present invention, the main wing panel 170 of FIGS. 8, 9, and 10 is part of the wing 150 of FIGS. 1 and 3. (The corresponding opposite wing 100 of FIGS. 1, 3, 4, and 5 is substantially a mirror image of wing 150.) Thus the side view of main wing panel 170 of FIG. 8 is presented as if it were viewed through the wall 18 of dump trailer 14 of FIG. 3.

Referring to FIGS. 8, 9, and 10, and in one preferred embodiment, main wing panel 170 comprises a framework 180 having mounting ears 172, 173, 174, and 175, joined to a plate of material, which forms the outer surface 199 of wing panel 170. Main wing panel is preferably constructed of steel, wherein framework 180 comprises steel tubing, angle, channel, and the like; and plate 199 comprises thick sheet steel or steel plate.

FIG. 11 is a perspective view of a contiguously retractable wing of the apparatus of the present invention, shown in a deployed position. FIG. 11 depicts the construction details of one preferred embodiment of the main wing panel 170 of FIGS. 8-10 and the attachment details of the main wing panel 170 to wall 16 of FIG. 3.

In the embodiment as depicted in FIG. 11, the framework 180 of the wing panel 170 comprises upper box beam 181, lower box beam 182, front box beam 183, rear box beam 184, and inner box beams 185 and 186. All of such box beams are suitably joined together to form framework 180, having rigid unitary construction. The overall structure of framework 180 also defines the inner surface 108 of wing panel 170, in the embodiment depicted in FIG. 11.

In the preferred embodiment, framework 180 further comprises angle pieces 187 and 188 disposed between upper box beam 181 and lower box beam 182. Angle pieces 187 and 188 are substantially aligned with ears 172 and 173, and recess 191 is formed between angle pieces 187 and 188. When main wing panel 170 is joined to a hanger bracket 110, and a hydraulic cylinder assembly 220 is fitted therebetween, such hydraulic cylinder assembly 220 is nested into the space formed by recess 191, and recess 111 of the corresponding hanger bracket, which is joined to main wing panel 170 at ears 172 and 173. In the retracted position, the central axis 1114, 1112 of the hydraulic cylinder is disposed in a plane 1124 substantially parallel to that of a plane 1116 intersecting the side wall 16 and a perpendicular distance (see 1302 of FIG. 4) is maintained between the central axis 1114, 1112 of the cylinder 220 and the pivotal axis of the pivotal connection. In one preferred embodiment, the pivotal axis 1118, 1122 is disposed about the receiving pin 104. As will be understood by those skilled in the mechanical arts, the pivotal axis is coaxial with receiving pin 104. It is to be further understood that there are a plurality of pivotal axes in the present invention.

More simply demonstrated, in a preferred embodiment depicted in FIG. 11, the recess of the wall 1104, 111 forms a first substantially U-shaped channel. The recess in the wing 192, 191 forms a slightly larger second substantially U-shaped channel with sufficient width and depth to permit the U-shaped channel of the wing to nest over the U-shaped channel of the wall. These U-shaped channels have elongated oblong spaces that are vertically disposed when the wing is in its retracted position. The U-shaped channel of the wall is oppositely disposed from the U-shaped channel of the wing recess with the respective openings facing one another, thereby forming a lumen within which substantially all of the operating elements of the lifting portion may be enclosed. The U-shaped channel of the wall (and a hanger bracket if one is used) rests fully inside the slightly larger U-shaped channel of the wing forming a lumen within which the cylinder 1102, 220 is disposed. In a preferred embodiment, this nesting arrangement is incorporated at each cylinder disposed between the wing and the wall. For example, referring to FIG. 1, this nesting arrangement would be incorporated at cylinders 220 and 240 as well the corresponding cylinders (not depicted) on wing 150.

The recess of a first parallel wall comprises a first substantially U-shaped channel comprising a first elongated oblong space, a first open end, a first side wall, and a first closed end. The recess of a first contiguously retractable wing comprises a second substantially U-shaped channel comprising a second elongated oblong space, a second open end, a second side wall, and a second closed end. When the first contiguously retractable wing is in the retracted position, the first U-shaped channel has a vertically disposed opening, the second U-shaped channel has a vertically disposed opening, the first U-shaped channel is oppositely disposed the second U-shaped channel, the first elongated oblong space and the second elongated oblong space are contiguously disposed thereby forming a lumen. The first open end is contiguous with the second closed end, the second U-shaped channel nests over the first U-shaped channel, and the first hydraulic cylinder is disposed and enclosed in the lumen. The first side wall is contiguous with the second side wall. The first elongated oblong space comprises a first volume and the second elongated oblong space comprises a second volume and the lumen comprises a third volume. When the first contiguously retractable wing is in the retracted position, the first volume, the second volume and the third volume occupy the same space. When the first contiguously retractable wing is in a retracted position, the first volume, second volume and third volume occupy the same space such that the first volume and second volume overlap to form said the volume.

In one embodiment, hanger bracket 110 is nested entirely in recess 191 when hydraulic cylinder assembly 220 is in its retracted position (not shown) thereby forming a protrusion (see 1152 and 1154 of FIG. 3) of substantially the same magnitude as the wing panel 170 width 198 from wall 16 in the direction of 1108. In like manner, framework 180 further comprises angle pieces 189 and 190 disposed between upper box beam 181 and lower box beam 182, forming recess 192 therebetween, which provides a space 1104 for a second hydraulic cylinder assembly 1102 to reside when main wing panel 170 is in the retracted position. In one embodiment, hanger bracket 1106 is nested entirely in recess 192 when hydraulic cylinder assembly 1102 is in its retracted position thereby forming a protrusion (see 1152 and 1154 of FIG. 3) of substantially the same magnitude as the wing panel 170 width 198 from wall 16 in the direction of 1108.

The present invention offers other additional advantages over the prior art and unexpected results of the design configuration. Referring again to U.S. Pat. No. 5,016,858, describing a load support frame that can be retracted to rest on top of a base frame, where in its retracted position, the central axis of the cylinder of the hydraulic mechanism is not disposed in a plane parallel to that of a plane intersecting the upper surface of the U-shaped channel section. Referring to FIG. 8 of U.S. Pat. No. 5,016,858, the attachment of piston rod (“80”) end at (“81”) to plates (“44 and 45”) prevents the support frame (“31”) from being collapsed onto and nesting within the U-shaped channel (“23”). As would be well known to one skilled in the art, in order to erect plates “44 and 45”, a perpendicular distance is required between the axis on which a force is applied, i.e., the central axis of cylinder “76” and the center at which a resulting moment is applied, i.e., the front pivot pin (“58”). In short, modification of the design in the U.S. Pat. No. 5,016,858 as suggested by the present invention would render it inoperable and not fit for its intended purpose.

In contrast, the present invention (referring to FIG. 4 herein), hydraulic cylinder 220 can be fully retracted such that the central axis 1112 of hydraulic cylinder 220 is disposed in a plane 1124 parallel to that of a plane 1116 intersecting the outer surface of side wall 16. With this non-obvious configuration, even though the central axis 1112 of hydraulic cylinder 220 maintains a parallel configuration with side wall 16, a perpendicular distance (see 1304 of FIG. 5 for perpendicular distance in the deployed cylinder and 1302 of FIG. 4 for the perpendicular distance in the retracted cylinder) is maintained between the central axis 1112 of hydraulic cylinder 220 and receiving pin 104, thereby allowing hydraulic cylinder 220 to erect the wing panel 120 while simultaneously reducing the profile of the cylinder assembly and allowing it to nest within the recess of the wing and the wall.

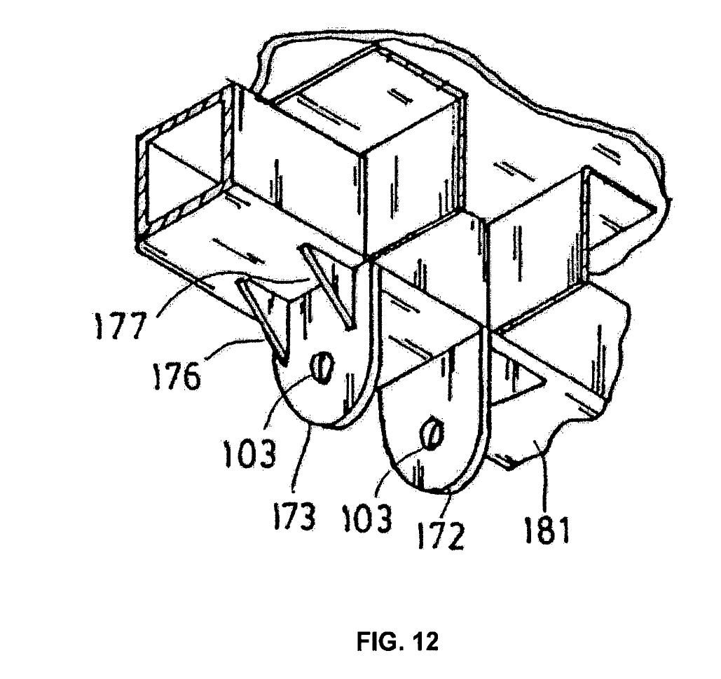

FIG. 12 is a detailed perspective view of attachment ears 172/173 on the main wing panel 170 of FIG. 11. Ears 172 and 173 are joined to upper box beam 181, and reinforced with gussets 176 and 177 to provide strong attachment to box beam 181, as such ears 172, 173, 174, and 175 carry the entire weight of wing panel 170 in operation. Each of such ears et seq. is provided with a hole 103, through which is fitted a joining pin 104, which joins wing panel 170 to hanger bracket 110 (see FIGS. 4 and 5).

In one embodiment of the wing panel 170 of FIG. 11, box beams 181, 182, 183, 184, 185, and 186 of framework 180 were made of 6 inch by 6 inch by 0.187 inch thick carbon steel tubing; angle pieces 187, 188, 189, and 190 were made of 6 inch by 8 inch by 0.5 inch thick carbon steel angle iron; and plate 199 was made of 0.25 inch thick carbon steel plate. The length 196 of wing panel 170 was approximately 30 feet; the height 197 of wing panel 170 was approximately 6 feet; and the thickness of wing panel 170 was approximately 6.25 inches. The entire assembly of this embodiment of wing panel 170 was of welded construction. Wing panel 170 was suspended on the side of dump trailer 14 (see FIG. 3) by a pair of hanger brackets 110 (see FIG. 7), joined to wing panel 170 at ears 187 and 188, and 189 and 190.

It is to be understood that wing panel 170 may be made of a variety of materials, and having a range of sizes, weights, and structural strengths, depending upon the exact application. The specific dimensions of wing panel 170 are made to substantially match the dimensions of the particular dump trailer. Thus wing panel 170 preferably has a height 197 of from about 4 to about 8 feet. It is preferred that the lengths 196 (see FIG. 11) of the wings be substantially equal to the lengths of the dump trailer 14 (see FIG. 1) or the dump truck (not shown) to which the wings are connected. It is further preferred that wing panel 170 is raised by a pair of hydraulic cylinder assemblies as previously described, and shown in FIG. 1. However, alternative embodiments, such as the use of a single high-powered hydraulic cylinder assembly, or three or more hydraulic cylinder assemblies, to raise wing panel 170 are also possible, and are within the scope of the present invention.

With regard to weight and structural strength, if the application were the receiving of lighter weight debris, e.g. wood and drywall from residential construction, wing panel 170 could be of considerably lighter weight and strength than the embodiment instantly described. For example, wing panel 170 could be fabricated of aluminum.

One preferred use for the applicant's invention is in bridge demolition. FIG. 2 of applicant's U.S. Pat. No. 6,155,649 illustrates one preferred aspect of applicant's process. In this embodiment, a bridge deck 48 is being demolished. As is known to those skilled in the art, a bridge deck is the surface of the bridge upon which vehicular traffic rides and can be comprised of or consist of concrete, steel, wood, etc. In one preferred embodiment, the bridge deck 48 consists essentially of reinforced concrete supported by steel girders 50.

Reinforced concrete bridge decks are well known to those skilled in the art and are described, e.g., in U.S. Pat. Nos. 5,579,361, 5,664,378, 5,639,358, 5,595,034, 5,509,243, 5,449,563, 5,427,819, and the like. The entire disclosure of each of these United States patents is hereby incorporated by reference into this specification.

It will be apparent that the rubble produced in demolition of a bridge comprises large, heavy chunks of concrete and/or steel, and that a strong, rigid structure of wing panel 170, as recited in the preferred embodiment described, is required in such demolition. However, it is to be understood that numerous equivalent and suitable wing panel structures may be fabricated, comprising a framework 180 and a plate 199. For example such a framework 180 may comprise a matrix of more box beams having smaller sizes, but providing the equivalent overall strength required to withstand the impact of the falling steel and concrete rubble. Thus the operative requirements for wing panel 170 are that plate 199 is of sufficient thickness and shear strength to resist penetration thereof by falling rubble; and that framework 180 has sufficiently high section moduli in the length and height directions to resist deformation when rubble impacts upon wing panel 170.

The preferred embodiment of the applicant's mobile receptacle has been described wherein the contiguously retractable wing comprises a hanger bracket, a hydraulic cylinder assembly, and a main wing panel. In an alternative embodiment (not shown), the structure of the hanger bracket is formed as an integral part of the side of the dump trailer, and the contiguously retractable wing comprises a hydraulic cylinder assembly and a main wing panel. In this configuration, a mounting ear 112 such as one depicted in FIG. 6 may be fixedly and directly attached to the side of the dump trailer. The dimensional relationship of the pivot pin of the mounting ear to the side of the dump trailer is maintained in a like manner as having the J-shaped plates 114 and 116 of FIG. 6.

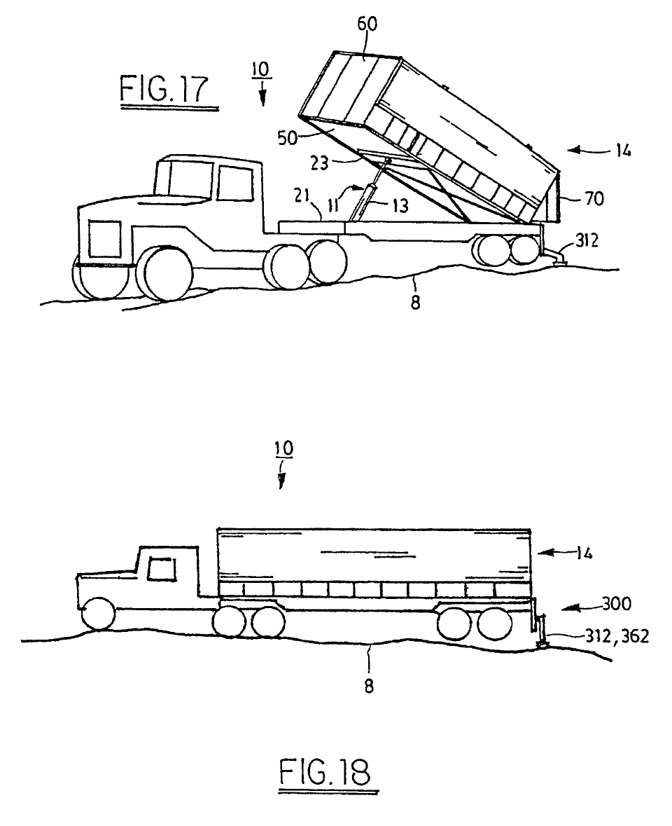

FIG. 17 is a perspective view of the winged trailer assembly of FIG. 1 with the dump trailer box in the raised position. Referring to FIGS. 1 and 17, and in the preferred embodiment depicted therein, it will be seen that hydraulic means 11 are preferably used to raise and lower the dump trailer box 23. In the embodiment depicted, these hydraulic means 11 are comprised of a hydraulic cylinder 13 that is pivotally attached to the base 21 of the dump trailer 14 at one end, and pivotally attached to the dump trailer box 23 at the other end. Such hydraulic means for tilting a dump trailer are well known. Reference may be had, e.g., to U.S. Pat. No. 3,674,312 (double box dump trailer), U.S. Pat. Nos. 4,317,593, 5,480,214, 5,917,493, and the like. The entire disclosure of each of these United States patents is hereby incorporated by reference into this specification.

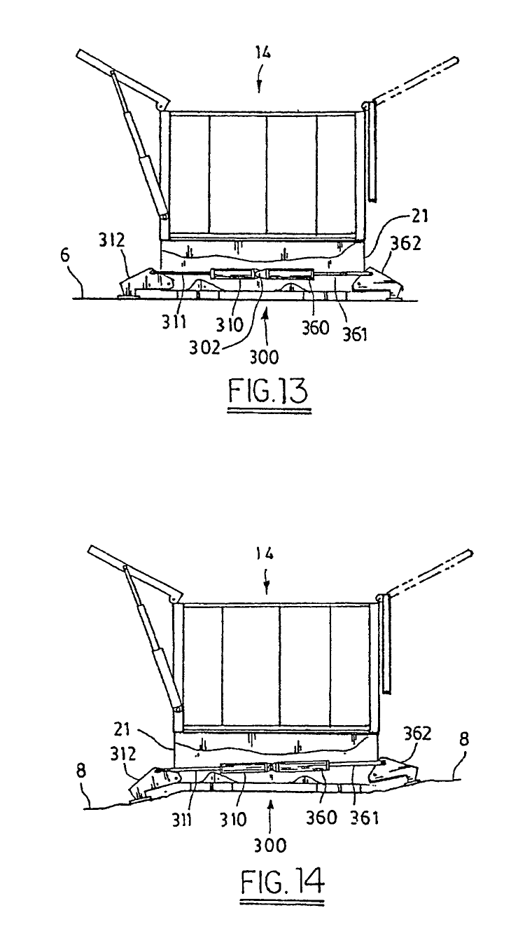

FIG. 13 is a rear elevation view of the apparatus of FIG. 1 showing the use of stabilizing and leveling means of the apparatus. Such stabilizing means effectively provides leveling capability of dump trailer 14, and wider base for dump trailer 14 during a demolition operation, preventing the dump trailer 14 from tipping over if a heavy amount of rubble suddenly falls onto only one wing panel. Thus the safety of the applicant's demolition process is greatly increased.

Referring to FIG. 13, stabilizing means 300 is similar in function to the leveler assembly described in U.S. Pat. No. 5,971,493, the entire disclosure of which is hereby incorporated by reference into this specification. This patent describes and claims: “ . . . An automatic leveler for a vehicle having a tilting dump box, comprising: oppositely disposed first and second hydraulic leveling strut means, for laterally leveling the dump box for dumping operations when the vehicle is parked on laterally sloping terrain; a low pressure hydraulic pump communicating hydraulically with said first and second leveling strut means, for initially extending and taking up slack in each said leveling strut means; a high pressure hydraulic pump communicating hydraulically with said first and second leveling strut means, for providing leveling extension of each said leveling strut means; valve means hydraulically communicating with said high pressure pump and each said leveling strut means, for selectively extending each said leveling strut means; and tilt switch means communicating with said valve means, for signaling said valve means for selectively extending and retracting either of said leveling strut means according to any predetermined lateral tilt detected by said tilt switch means.”

One may use the leveling device of U.S. Pat. No. 5,971,493 as the stabilizing means 300. Alternatively, one may use other conventional leveling devices such as, e.g., the leveling devices described in one or more of U.S. Pat. No. 3,044,832 (fluid stabilizing means for semi-trailer tilting bodies), U.S. Pat. No. 3,203,735 (fluid operated tilting dump truck stabilizer), U.S. Pat. No. 3,464,755 (dump trailer safety device), U.S. Pat. Nos. 3,756,424, 3,921,128 (truck roll warning system), U.S. Pat. No. 4,036,528 (truck with tiltable body), U.S. Pat. No. 4,705,295 (material handling vehicle stabilizer), U.S. Pat. No. 4,154,682 (semi-dump truck level indicator), U.S. Pat. No. 4,261,616 (apparatus for preventing the tipping of dump trucks), U.S. Pat. No. 4,375,903 (vehicle suspension system augmenter), U.S. Pat. Nos. 4,469,976, 4,573,742 (hydraulic stabilizing mechanism for use with hydraulic elevating system), U.S. Pat. No. 4,952,908 (trailer stability monitor), U.S. Pat. Nos. 5,348,171, 5,706,960 and the like. The entire disclosure of each of these United States patents is hereby incorporated by reference into this specification.

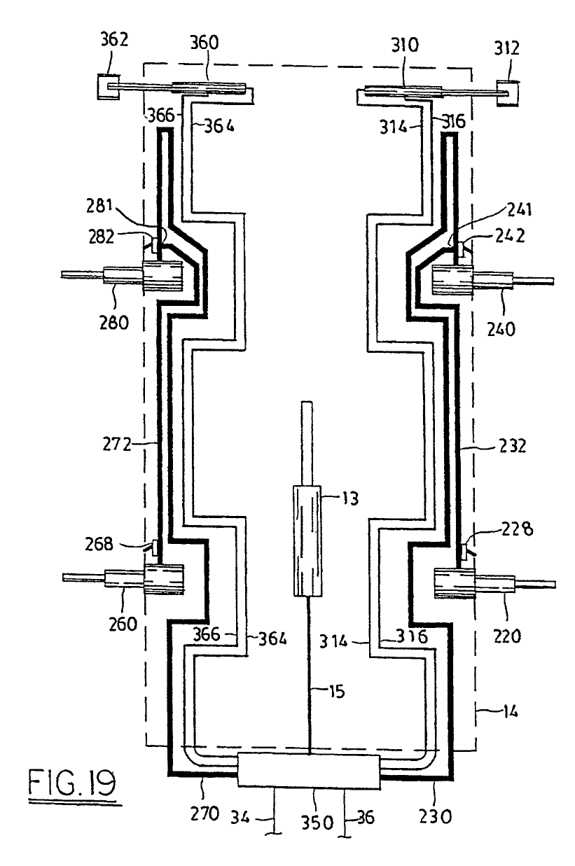

In the preferred embodiment illustrated in FIG. 13, stabilizing means 300 comprises a hydraulic cylinder 310 pivotally connected to a first outrigger 312, and a hydraulic cylinder 360 pivotally connected to a second outrigger 362. In this embodiment, dump trailer 14 is depicted in use on level ground 6, and each of the hydraulic cylinders 310 and 360 have caused their respective rods 311 and 361 to deploy outriggers 312 and 362 a substantially equal distance; and each of these outriggers 312 and 362 is substantially aligned with the other such outrigger, and contiguous with level ground 6. Each of hydraulic cylinders 310 and 360 are pivotably connected to dump trailer base 21 of dump trailer 14. In the embodiment shown in FIG. 13, cylinders 310 and 360 are connected to base 21 by a shared attachment pin 302 disposed at or about the rear end of the dump trailer base as it is mounted on dump trailer 14 (refer to FIGS. 17 and 18). In one embodiment, when deployed, cylinders 310 and 360 cause their respective rods 311 and 361 to extend the outriggers 312 and 362 outwardly from opposite sides of the dump trailer base beneath side walls 16 and 18. In another embodiment, the outriggers 312 and 362 outwardly from the rear of the dump trailer base. With the outrigger and stabilizer located at the end of the box rather than on the sides of the box, the width profile of the mobile receptacle is reduced or minimized, thereby enabling it to be transported on public highways in compliance with transportation statutes and regulations.

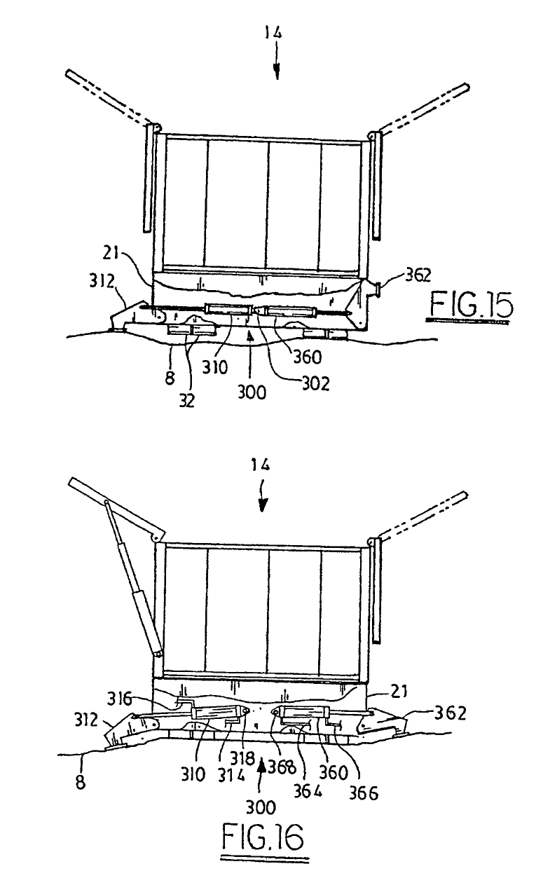

FIG. 14 is an elevation view of the apparatus of FIG. 1 showing the use of stabilizing means on uneven ground. By comparison with FIG. 13, in the elevation view presented in FIG. 14, hydraulic cylinders 310 and 362 have caused their respective rods 311 and 361 to move the outriggers 312 and 362 unequal distances to accommodate uneven ground 8. In the embodiment depicted in FIG. 14, each of the hydraulic cylinders 310 and 362 are preferably independently operated and, thus, are capable of being activated to different extents.

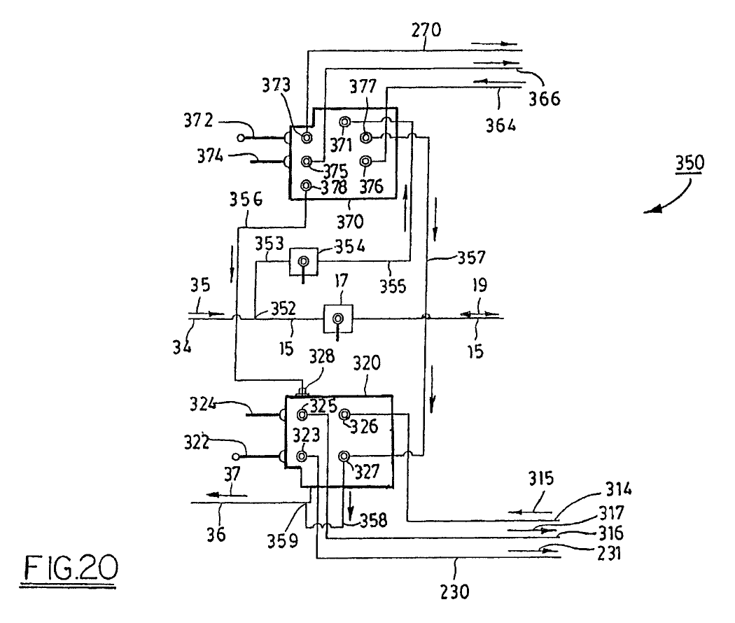

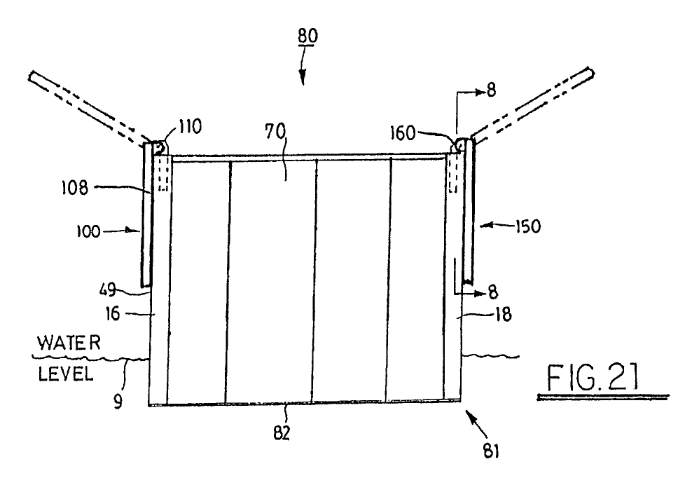

By way of further comparison, the leveling means 300 of FIG. 14 is further depicted in FIG. 16 and FIG. 19 as comprising hydraulic cylinders 310 and 360 connected to independent hydraulic feed lines. Hydraulic cylinder 310 is connected to supply line 314 and return line 316, which are connected to hydraulic control system 350. In like manner, hydraulic cylinder 360 is connected to supply line 364 and return line 366, which are connected to hydraulic control system 350. Hydraulic control system 300 comprises independent control valves for operating hydraulic cylinders 310 and 360, the details of which are shown in FIG. 20, and which are discussed subsequently in this specification.

FIG. 15 is an elevation view of the apparatus of FIG. 1 showing an alternative use of stabilizing means on uneven ground. In the embodiment depicted in FIG. 15, outrigger 312 has been deployed by hydraulic cylinder 310, in order to level dump trailer 14, and compensate for uneven ground 8 beneath wheels 32 of dump trailer 14. In this embodiment, hydraulic cylinder 360 has raised outrigger 362 to the retracted position, as deployment of outrigger 362 in this situation is optional.

FIG. 16 is an elevation view of an alternative stabilizing means of the invention in which two or more outriggers can be independently positioned and controlled. In the embodiment depicted in FIG. 16, hydraulic cylinders 310 and 360 are separately mounted and pivotably joined to the base of dump trailer by pins 318 and 368, respectively.

FIGS. 17 and 18 depict further uses of the stabilizing means of the applicant's mobile receptacle. FIG. 17 is a perspective view of the dump trailer assembly 14 of FIG. 1 with its receptacle 23 in the raised position, and with outriggers 312 and 316 (not shown) deployed for added stability during a dumping operation. FIG. 18 is a side view of the winged tractor-trailer assembly 10 of FIG. 1 in which the leveling means 300 of the apparatus can deploy outriggers 312 and 362 to accommodate uneven ground 8 along the length of the winged tractor-trailer assembly 10.

FIG. 19 is a schematic view of a hydraulic circuit for operation of the dump box, the wings and the stabilizing means of the present invention; and FIG. 20 is a schematic view of the operating control valves of the hydraulic circuit of FIG. 19. In the subsequent description, the terms “line” and “hydraulic line” are defined as any suitable fluid conduit, hose, tube, or pipe that is capable of conveying hydraulic fluid under high pressure.

Referring to FIG. 19, the overall operation of the hydraulic system will be described first. High pressure hydraulic fluid is supplied to hydraulic control system 350 through line 34 and removed from control system through line 36. In one embodiment, a single action hydraulic cylinder 13, connected to control system 350 by line 15, is used to raise and lower the box of dump trailer 14 as shown in FIG. 17, and indicated in dotted line form in FIG. 19.

In one preferred embodiment, single action hydraulic cylinders 220 and 240 are used to raise and lower wing 100 (see FIG. 1). Hydraulic line 230 is routed to the rear of the dump trailer, where a tee 241 directs hydraulic fluid into and out of hydraulic cylinders 240 and 220. Safety shutoff valves 228 and 242 are provided to close off the flow of hydraulic fluid to hydraulic cylinders 220 and 240, in the event that the wing must be locked in place for maintenance, inspection, or other similar activities.

In like manner, hydraulic cylinders 260 and 280 are used to raise and lower wing 150 (see FIG. 1) in substantially the same way as described for wing 100. The hydraulic system that operates wing 150 is substantially a mirror image of the system for wing 100, comprising single action hydraulic cylinders 260 and 280, hydraulic line 270, tee 281, and safety shutoff valves 268 and 282.

In the preferred embodiment of the applicant's mobile receptacle, the stabilizing means of the receptacle comprises a pair of double action hydraulic cylinders. Referring to FIGS. 16 and 19, outrigger 312 is operated by cylinder 310, which is connected to hydraulic control system 350 by lines 314 and 316. In like manner, outrigger 362 is operated by cylinder 360, which is connected to hydraulic control system 350 by lines 364 and 366.

FIG. 20 is a detailed schematic view of the hydraulic control system 350 of FIG. 1 and FIG. 19. Referring to FIG. 20, high pressure hydraulic fluid is supplied to control system 350 through line 34, as indicated by arrow 35. High pressure hydraulic fluid is discharged from control system 350 through line 36, as indicated by arrow 37. In the preferred embodiment, the supply of high pressure hydraulic fluid is provided by a hydraulic pump (not shown) and reservoir (not shown), which are installed on tractor 12 (see FIG. 1). Lines 34 and 36 are preferably attached to such a hydraulic pump by the use of quick connect fittings (not shown), when the tractor 12 is attached to the applicant's dump trailer 14 (see FIG. 1).

Referring again to FIG. 20, the flow of hydraulic fluid through line 34 into control system 350 is split at tee 352 into a portion flowing in line 15 and a portion flowing in line 353. Line 15 directs hydraulic fluid through safety shutoff valve 17, and through a raise/lower control valve (not shown) to extend and retract hydraulic cylinder 13 (see FIGS. 1 and 19), which is operatively connected to the box of dump trailer 14 (see FIGS. 1 and 19).

The portion of high pressure hydraulic fluid in line 353 flows through safety shutoff valve 354, through line 355, and enters port 371 of valve block 370. This flow into valve block 370 is further split by internal porting (not shown) within valve block 370 into a portion used to operate outrigger 362 (see FIG. 19) and wing 150 (see FIG. 1), and a portion which flows out of port 378 of valve block 370, through line 356, and into port 328 of valve block 320. Valve block 320 is used to operate outrigger 312 (see FIG. 19) and wing 100 (see FIG. 1).

Referring again to FIG. 20, lever 322 of valve block 320 is used to operate wing 100 of the dump trailer 14 (see FIG. 1). Lever 322 has three positions (not shown): raise, hold, and lower. In the raise position, hydraulic fluid is directed out of port 323 through line 230 in the direction of arrow 231, thereby raising wing 100 of dump trailer 14 (see FIG. 1). In the lower position, hydraulic fluid is directed through line 230 in the direction opposite of arrow 231, into port 323, and out of valve block 320 through line 36 in the direction of arrow 37, thereby lowering wing 100 of dump trailer 14 (see FIG. 1). In the neutral position, no flow occurs through line 230, and the position of wing 100 is maintained constant.

Lever 324 of valve block 320 is used to operate outrigger 312 of the dump trailer 14 (see FIG. 16). Lever 324 also has three positions (not shown): raise, hold, and lower. In the raise position, hydraulic fluid is directed out of port 325 through line 316 in the direction of arrow 317 and into double action hydraulic cylinder 310 (see FIG. 19), while simultaneously hydraulic fluid flows out of cylinder 310, through line 314 in the direction of arrow 315, into port 326 of valve block 320, out of port 327 of valve block 320, through line 358 to tee 359, and on through line 36 back to the hydraulic pump and reservoir (not shown) on tractor 12 (see FIG. 1).

In the lower outrigger position, hydraulic fluid is directed out of port 326 through line 314 in the direction opposite of arrow 315 and into double action hydraulic cylinder 310 (see FIG. 19), while simultaneously hydraulic fluid flows out of cylinder 310, through line 316 in the direction opposite of arrow 317, into port 325 of valve block 320, out of port 327 of valve block 320, through line 358 to tee 359, and on through line 36 back to the hydraulic pump and reservoir (not shown) on tractor 12 (see FIG. 1). In the neutral position, no flow occurs through lines 314 and 316, and the position of outrigger 312 is maintained constant.

It will be apparent to one skilled in the art that the operation of wing 150 (see FIG. 1) and outrigger 362 (see FIG. 16) are substantially identical to the corresponding operations of wing 100 and outrigger 312 previously described. The corresponding levers 372 and 374, and the corresponding ports 373, 375, and 376 perform substantially the same function as levers 322 and 324, and ports 323, 325, and 326. In operation of the system, hydraulic fluid is exhausted from valve block 370, through lines 357 and 358, through tee 359, and through line 36. It will be further apparent that although no details on the internal fluid passageways of valve blocks 320 and 370 are provided, such hydraulic control valve blocks are well known in the art.

FIG. 21 is a back elevation view of a further embodiment of a receptacle which is buoyant in water, and which further comprises contiguously retractable wings. Referring to FIG. 21, applicant's buoyant receptacle 80 comprises much of the same structure as applicant's mobile receptacle 14 of FIG. 3, comprising a box 81 formed by a front wall (not shown), a rear wall 70, side walls 16 and 18, and contiguously retractable wings 100 and 150. Buoyant receptacle 80 further comprises a bed 82, and means for sealing walls 16, 18, 60, and 70 to bed 82, and means for sealing such walls to each other during deployment in the water. Such sealing means disposed between walls 16, 18, 60, and 70 and bed 82 renders receptacle 80 free of leaks when it is deployed in water and partially immersed, as indicated by water level 9. (It will be apparent that water level 9 as depicted in FIG. 21 is for illustrative purposes only, and that buoyant receptacle 80 will become considerably further immersed in the water as receptacle 80 is filled with debris.)

In one embodiment, such sealing means comprises welding of walls 16, 18, 60, 70, and bed 82 to each other. In another embodiment, such sealing means comprises caulking in the joints between walls 16, 18, 60, and 70, and bed 82. In one preferred embodiment, sealing means at rear wall 70, which seals rear wall 70 to walls 16 and 18, and bed 82, comprises a gasket, such that rear wall 70 is deployable as a discharge door for the unloading of buoyant receptacle 80 in the same manner as shown for rear wall 70 of dump trailer 18 of FIG. 17.

In another embodiment (not shown) buoyant receptacle 80 is provided with moving means comprising a marine motor, e.g. an outboard boat motor. In another embodiment (not shown), buoyant receptacle is provided with towing lugs or cleats for attachment of towropes thereto, and buoyant receptacle is towed by a powered boat.

In yet another embodiment (not shown), buoyant receptacle 80 is provided with rails beneath bed 82, which are suitably engagable with the base 21 of a dump trailer 14 (see FIG. 1). In such an embodiment, applicant's buoyant receptacle 80 replaces dump box 23 in FIG. 1, and applicant's buoyant mobile receptacle is deployable in a manner similar to that of a roll-off dumpster, which is well known in the art of debris and refuse collection. In a further embodiment (not shown), buoyant receptacle 80 is provided with lifting lugs, and buoyant receptacle 80 is deployed from a mobile carrier such as a trailer base to the body of water using an overhead crane. Such movement of a box container from a trailer base to other shipping means, e.g. a cargo ship or a freight train are well known in the cargo shipping arts.

The present invention has been described in connection with a preferred embodiment. However, it is to be understood that there is no intent to limit the invention to the embodiment described. On the contrary, the intent is to cover all alternatives, modifications, and equivalents as may be included within the spirit and scope of the invention as defined by the appended claims.

We claim:

1. A mobile receptacle for catching debris comprised of:
a. a base comprising a forward end and a rearward end;
b. a box comprising first and second parallel walls extending upwardly from a flat bed disposed upon said base, wherein each of said first and second parallel walls comprises an inner surface and an outer surface, said first parallel wall comprises a vertically disposed wall recess in said outer surface thereof, and wherein said first parallel wall comprises a first plane;
c. a first hydraulic cylinder assembly comprising a first end and a second end aligned along a central axis of said first hydraulic cylinder, said first end of said first hydraulic cylinder assembly operatively connected to said outer surface of said first parallel wall; and
d. a first contiguously retractable wing comprising an inner surface, an outer surface, and a wing recess formed in said inner surface thereof, wherein:
i. said first contiguously retractable wing comprises a second plane;
ii. said first contiguously retractable wing comprises a width;
iii. said first contiguously retractable wing is pivotably connected about a pivotal axis to said first parallel wall at an upper edge of said first parallel wall;
iv. said first contiguously retractable wing is pivotably deployable from a retracted position to a raised position;
v. said second end of said first hydraulic cylinder assembly is operatively connected to said first contiguously retractable wing;
vi. wherein said central axis of said first hydraulic cylinder is disposed in a plane substantially parallel to said first plane;
vii. when said first contiguously retractable wing is in said retracted position, said first hydraulic cylinder is nested in said vertically disposed wall recess and in said wing recess; wherein said wing recess has a depth; and said first plane, said second plane, and said plane of said central axis of said first hydraulic cylinder are all substantially parallel to each other;
viii. wherein a perpendicular distance is maintained between said central axis of said first cylinder and said pivotal axis of said pivotal connection;
ix. wherein when said retractable wing is in said retracted position, a gap is formed between said outer surface of said first parallel wall and said inner surface of said first contiguously retractable wing, said gap having a width of from about 0.1 inches to about two inches;
x. wherein when said first contiguously retractable wing is in said retracted position, said vertically disposed wall recess of said first parallel wall is nested in said wing recess of said first contiguously retractable wing and has a protrusion substantially the same magnitude as the width of said retractable wing; and
xi. wherein an angle formed between said first contiguously retractable wing and said first parallel wall of said box is between 100 and 150 degrees when said first contiguously retractable wing is in said raised position.

2. The mobile receptacle of claim 1, wherein
i. said recess of said first parallel wall comprises a first substantially U-shaped channel comprising a first elongated oblong space, a first open end, a first side wall, and a first closed end,
ii. said recess of said first contiguously retractable wing comprises a second substantially U-shaped channel comprising a second elongated oblong space, a second open end, a second side wall, and a second closed end,
iii. when said first contiguously retractable wing is in said retracted position,
1. said first U-shaped channel has a vertically disposed opening,
2. said second U-shaped channel has a vertically disposed opening,
3. said first U-shaped channel is oppositely disposed said second U-shaped channel, said first elongated oblong space and said second elongated oblong space are contiguously disposed thereby forming a lumen;
4. said first open end is contiguous with said second closed end,
5. said second U-shaped channel nests over said first U-shaped channel, and
6. said first hydraulic cylinder is disposed and enclosed in said lumen.

3. The mobile receptacle of claim 2, wherein said first side wall is contiguous with said second side wall.

4. The mobile receptacle of claim 3, wherein said first elongated oblong space comprises a first volume, said second elongated oblong space comprises a second volume, and said lumen comprises a third volume, wherein when said first contiguously retractable wing is in said retracted position, said first volume, said second volume and said third volume occupy the same space.

5. The mobile receptacle of claim 4, wherein when said first contiguously retractable wing is in said retracted position, said first volume, said second volume and said third volume occupy the same space such that said first volume and said second volume overlap to form said third volume.

6. The mobile receptacle of claim 5, wherein said gap has a width of from about 0.1 inches to about 1 inches.

7. The mobile receptacle of claim 6, further comprising a second hydraulic cylinder assembly comprising a first end and a second end aligned along a central axis, wherein said first end of said second hydraulic cylinder assembly is operatively connected to said outer surface of said first parallel wall, and said second end of said second hydraulic cylinder assembly is operatively connected to said first contiguously retractable wing.

8. The mobile receptacle of claim 7, wherein said first contiguously retractable wing further comprises a framework forming said wing recess, and a plate joined to said framework.

9. The mobile receptacle of claim 8, further comprising:
a. a second hydraulic cylinder assembly comprising a first end and a second end aligned along a central axis of said second hydraulic cylinder, said first end of said second hydraulic cylinder assembly operatively connected to said outer surface of said second parallel wall; and
b. a second contiguously retractable wing comprising an inner surface, an outer surface, and a wing recess formed in said inner surface thereof, wherein:
i. said second contiguously retractable wing is pivotably connected about a pivotal axis to said second parallel wall at an upper edge of said second parallel wall;
ii. said second contiguously retractable wing is pivotably deployable from a retracted position to a raised position;
iii. said second end of said second hydraulic cylinder assembly is operatively connected to said second contiguously retractable wing;
iv. when said second contiguously retractable wing is in said retracted position, said second hydraulic cylinder is nested in said vertically disposed wall recess of said second parallel wall and in said wing recess of said second contiguously retractable wing; and said vertically disposed wall recess of said second parallel wall, said wing recess of said second contiguously retractable wing, and said central axis of said second hydraulic cylinder are all substantially parallel to each other and substantially parallel to said second parallel wall;
v. wherein when said second contiguously retractable wing is in said retracted position, a gap is formed between said outer surface of said second parallel wall and said inner surface of said second contiguously retractable wing, said gap having a width of from about 0.1 to about two inches; and
vi. wherein an angle formed between said second contiguously retractable wing and said second parallel wall of said box is between 100 and 150 degrees when said second contiguously retractable wing is in said raised position.

10. The mobile receptacle of claim 9, wherein when said second contiguously retractable wing is in said retracted position, said vertically disposed wall recess of said second parallel wall is nested in said wing recess of said second contiguously retractable wing.

11. The mobile receptacle of claim 10, wherein said second contiguously retractable wing further comprises a framework forming said wing recess of said second contiguously retractable wing, and a plate joined to said framework of said second contiguously retractable wing.

12. The mobile receptacle of claim 11, further comprising a first hanger bracket having a recess, wherein when said first contiguously retractable wing is in said retracted position, said first hanger bracket is nested entirely within said recess of said first contiguously retractable wing and said recess of said first hanger bracket.

13. The mobile receptacle of claim 12, wherein said first hanger bracket is suspended upon an upper edge of said first parallel wall, said first contiguously retractable wing, and first hydraulic cylinder operatively connected to said first hanger bracket and to said first contiguously retractable wing.

14. A mobile receptacle for catching debris comprised of:
a. a base comprising a forward end and a rearward end;
b. a box comprising first and second parallel walls extending upwardly from a flat bed disposed upon said base, wherein each of said first and second parallel walls comprises an inner surface and an outer surface, said first parallel wall comprises a vertically disposed wall recess in said outer surface thereof, and wherein said first parallel wall comprises a first plane;
c. a first hydraulic cylinder assembly comprising a first end and a second end aligned along a central axis of said first hydraulic cylinder, said first end of said first hydraulic cylinder assembly operatively connected to said outer surface of said first parallel wall; and
d. a first contiguously retractable wing comprising an inner surface, an outer surface, a wing recess formed in said inner surface thereof, and a framework forming said wing recess, and a plate joined to said framework wherein:
iv. said first contiguously retractable wing comprises a second plane;
v. said first contiguously retractable wing comprises a width;
vi. said first contiguously retractable wing is pivotably connected about a pivotal axis to said first parallel wall at an upper edge of said first parallel wall;
vii. said first contiguously retractable wing is pivotably deployable from a retracted position to a raised position;
viii. said second end of said first hydraulic cylinder assembly is operatively connected to said first contiguously retractable wing;
ix. wherein said central axis of said first hydraulic cylinder is disposed in a plane substantially parallel to said first plane;
x. when said first contiguously retractable wing is in said retracted position, said first hydraulic cylinder is nested in said vertically disposed wall recess and in said wing recess; wherein said wing recess has a depth; and said first plane, said second plane, and said plane of said central axis of said first hydraulic cylinder are all substantially parallel to each other;
xi. wherein a perpendicular distance is maintained between said central axis of said first cylinder and said pivotal axis of said pivotal connection;
xii. wherein when said retractable wing is in said retracted position, a gap is formed between said outer surface of said first parallel wall and said inner surface of said first contiguously retractable wing, said gap having a width of from about 0.1 inches to about one inch;
xiii. wherein when said first contiguously retractable wing is in said retracted position, said vertically disposed wall recess of said first parallel wall is nested in said wing recess of said first contiguously retractable wing and has a protrusion of about 6.25 inches;
xiv. wherein an angle formed between said first contiguously retractable wing and said first parallel wall of said box is between 100 and 150 degrees when said first contiguously retractable wing is in said raised position;
e. a second hydraulic cylinder assembly comprising a first end and a second end aligned along a central axis, wherein said first end of said second hydraulic cylinder assembly is operatively connected to said outer surface of said first parallel wall, and said second end of said second hydraulic cylinder assembly is operatively connected to said first contiguously retractable wing.
f. a second hydraulic cylinder assembly comprising a first end and a second end aligned along a central axis of said second hydraulic cylinder, said first end of said second hydraulic cylinder assembly operatively connected to said outer surface of said second parallel wall; and
g. a second contiguously retractable wing comprising an inner surface, an outer surface, a wing recess formed in said inner surface thereof, and a framework forming said wing recess of said second contiguously retractable wing, and a plate joined to said framework of said second contiguously retractable wing wherein:
i. said second contiguously retractable wing is pivotably connected about a pivotal axis to said second parallel wall at an upper edge of said second parallel wall;
ii. said second contiguously retractable wing is pivotably deployable from a retracted position to a raised position;
iii. said second end of said second hydraulic cylinder assembly is operatively connected to said second contiguously retractable wing;
iv. when said second contiguously retractable wing is in said retracted position, said second hydraulic cylinder is nested in said vertically disposed wall recess of said second parallel wall and in said wing recess of said second contiguously retractable wing; and said vertically disposed wall recess of said second parallel wall, said wing recess of said second contiguously retractable wing, and said central axis of said second hydraulic cylinder are all substantially parallel to each other and substantially parallel to said second parallel wall;
v. wherein when said second contiguously retractable wing is in said retracted position, a gap is formed between said outer surface of said second parallel wall and said inner surface of said second contiguously retractable wing, said gap having a width of from about 0.1 to about two inches;
vi. wherein an angle formed between said second contiguously retractable wing and said second parallel wall of said box is between 100 and 150 degrees when said second contiguously retractable wing is in said raised position;
vii. wherein when said second contiguously retractable wing is in said retracted position, said vertically disposed wall recess of said second parallel wall is nested in said wing recess of said second contiguously retractable wing;
viii. a first hanger bracket having a recess, wherein when said first contiguously retractable wing is in said retracted position, said first hanger bracket is nested entirely within said recess of said first contiguously retractable wing and said recess of said first hanger bracket, wherein said first hanger bracket is suspended upon an upper edge of said first parallel wall, said first contiguously retractable wing, and first hydraulic cylinder operatively connected to said first hanger bracket and to said first contiguously retractable wing;
h. a second hanger bracket having a recess, wherein when said first contiguously retractable wing is in said retracted position, said second hanger bracket is nested entirely within said recess of said first contiguously retractable wing and said recess of said second hanger bracket, wherein said second hanger bracket is suspended upon an upper edge of said second parallel wall, said second contiguously retractable wing, and second hydraulic cylinder operatively connected to said second hanger bracket and to said second contiguously retractable wing;
i. said recess of said first parallel wall comprises a first substantially U-shaped channel comprising a first elongated oblong space, a first open end, a first side wall, and a first closed end,
j. said recess of said first contiguously retractable wing comprises a second substantially U-shaped channel comprising a second elongated oblong space, a second open end, a second side wall, and a second closed end,
k. when said first contiguously retractable wing is in said retracted position,
i. said first U-shaped channel has a vertically disposed opening,
ii. said second U-shaped channel has a vertically disposed opening,
iii. said first U-shaped channel is oppositely disposed said second U-shaped channel, said first elongated oblong space and said second elongated oblong space are contiguously disposed thereby forming a lumen;
iv. said first open end is contiguous with said second closed end,
v. said second U-shaped channel nests over said first U-shaped channel, and
vi. said first hydraulic cylinder is disposed and enclosed in said lumen.

15. The mobile receptacle of claim 14, wherein said first side wall is contiguous with said second side wall.

16. The mobile receptacle of claim 15, wherein
a. said first elongated oblong space comprises a first volume and said second elongated oblong space comprises a second volume,
b. said lumen comprises a third volume, and
c. when said first contiguously retractable wing is in said retracted position, said first volume, said second volume and said third volume occupy the same space.

17. The mobile receptacle of claim 16, wherein when said first contiguously retractable wing is in said retracted position, said first volume, said second volume and said third volume occupy the same space such that said first volume and said second volume overlap to form said third volume.

18. The mobile receptacle of claim 17, further comprised of means for stabilizing said receptacle, said means for stabilizing said receptacle comprising:
a. a first outrigger pivotally connected to a left outer region of said rearward end of said base;
b. a second outrigger pivotally connected to a right outer region of said rearward end of said base;
c. a first outrigger hydraulic cylinder comprising a first end and a second end, said first end of said first outrigger hydraulic cylinder pivotally connected to a central region of said rearward end of said base, and said second end of said first outrigger hydraulic cylinder pivotally connected to said first outrigger; and
d. a second outrigger hydraulic cylinder comprising a first end and a second end, said first end of said second outrigger hydraulic cylinder pivotally connected to said central region of said rearward end of said base, and said second end of said second outrigger hydraulic cylinder pivotally connected to said second outrigger.

19. The mobile receptacle of claim 18, wherein said first end of said first outrigger hydraulic cylinder is pivotally connected to said first end of said second outrigger hydraulic cylinder.
